(19) United States
(12) Patent Application Publication
(10) Pub. No.: US 2023/0056054 A1
(43) Pub. Date: Feb. 23, 2023

(54) Method and Device for Providing Laminate Panels Provided with Individualized Decorations

(71) Applicant: Flooring Technologies Ltd., Kalkara (MT)

(72) Inventor: Norbert KALWA, Horn-Bad Meinberg (DE)

(21) Appl. No.: 17/792,307

(22) PCT Filed: Jan. 8, 2021
(86) PCT No.: PCT/EP2021/050269

§ 371 Date: Jul. 12, 2022

(30) Foreign Application Priority Data
Jan. 13, 2020 (EP) 20151433.8
Jan. 15, 2020 (EP) 20151966.7

(51) Int. Cl. B44C 5/04; B41M 5/00

(52) U.S. Cl. CPC B44C 5/0492; B41M 5/0076; B44C 5/0476; E04F 15/107

(57) ABSTRACT

Provided is a method for making laminate panels having individualized decors, in particular wood-based laminate panels, for a party B, in particular an end user, including the steps of providing at least one formatted laminate panel blank by a party A, in particular a laminate manufacturer, wherein the laminate panel blank includes a carrier plate pressed with a coating as a print base coat and at least one backing and connecting elements inserted into the panel edges, printing of at least one decor individually selected by the party B, in particular the end user, on the laminate panel blank by digital printing; and pressing at least one thermoplastic film onto the printed decoration as a wear layer.

### CROSS-REFERENCE TO RELATED APPLICATIONS

This application is the United States national phase of International Application No. PCT/EP2021/050269 filed Jan. 8 2021, and claims priority to European Patent Application Nos. 20151433.8 filed Jan. 13, 2020 and 20151966.7 filed Jan. 15, 2020, the disclosures of which are hereby incorporated by reference in their entirety.

### BACKGROUND OF THE INVENTION

### Field of the Invention

The disclosure relates to a method for providing laminate panels provided with individualized decorations, a laminate panel produced by this method and a device for carrying out this method.

### Description of Related Art

Laminate panels have become indispensable in a wide range of applications, especially as a replacement for real wood panels. A particularly large area of application is in the cladding of walls, ceilings and floors, where the respective cladding is composed of corresponding wall, ceiling and floor panels. Naturally, different areas of application place different demands on the surface finish of such laminate panels. A floor panel is thereby naturally exposed to much greater loads than, for example, wall or ceiling panelling.

The large-scale production of laminate panels involves a whole series of production steps that are largely the same for the different areas of application of laminate panels. First, a carrier board, for example made of a wood-based material such as chipboard, MDF, HDF or OSB, is provided and this is coated with several layers of possibly different materials. A decorative layer is applied to a possibly pre-treated surface of a wood-based panel. This can be done, for example, in the form of a printed impregnated paper. The decor can also be printed directly onto the upper surface of the wood-based panel. This can be done by means of printing rollers or a digital printer. Before the decoration is printed on, a base coat layer can also be applied to the surface of the wood-based panel, if necessary. This decor must be covered by at least one abrasion-resistant protective layer, e.g. of lacquer or resin, especially if the panel is to be used as a floor panel. The layer structure is then pressed in a press under the influence of pressure and temperature. Afterwards, the still large-format, now coated wood-based panel is divided into individual panels, which are provided with locking means in the form of a tongue and groove on the side surfaces, so that easy connection of the panels is possible.

A big topic in many product areas of wood-based panels today is customization. Customers often want a product that is tailored to their individual wishes and/or needs. In doing so, the customer is also prepared to accept a higher price for this additional service.

New technologies such as digital printing or 3D printing are creating opportunities for manufacturers to realize both small quantities (keyword: quantity 1) and new production possibilities outside the classic production lines. Many products are affected by these trends, including floor coverings. These were usually produced in large quantities per decor in the manufacturers' factories. The decors were usually developed by suppliers (designers, printers, etc.) and then distributed to the industry. A collection was then created from a certain number of decors by the flooring manufacturers and made available to the flooring dealers and thus also to the end user for selection.

In this approach, there used to be little to no room for individualization. It was also not possible to involve the end user. This was essentially true for all floor coverings, including laminate flooring.

In recent years, however, there have been increasing attempts to satisfy the desire for individualized floor coverings. However, the procedure was often still somewhat complicated, as the end user had to order the desired individualized floor covering from the manufacturer via the retailer. This not only led to sometimes very long delivery times but also to potential problems if the floor covering actually delivered differed significantly from a sample or a digitized image. Usually, the range of possible designs is also reduced so that not too much variety has to be processed at the manufacturer. Another problem is that very small delivery quantities then often have to be shipped. This leads to relatively high transport costs per square meter of product.

To solve this problem, a process according to EP 2 572 896 B1 was used, in which coated floorboard blanks are printed with a decor at the point-of-sale (POS) and then varnished off. However, this process has the disadvantage that the lacquers used are UV-curing systems (acrylates), which can lead to unpleasant odours due to the photoinitiators required. This must be avoided by means of exhaust air disposal. Furthermore, the acrylates are allergenic, which requires special training for POS staff and appropriate protective equipment for maintenance, cleaning or troubleshooting. The disposal of faulty batches/rejects is also not unproblematic for the employees. In addition, quality inspection is difficult for people untrained in UV coating technology. The use of UV lacquers is more suitable for industrial operations and less so for employees in hardware stores, timber trade, flooring stores, etc. Furthermore, it is hardly possible to vary the structuring of the surface, so that only one surface is available.

A similar process is described in EP 3 067 219 A1. The same disadvantages apply here as for the above-mentioned paper. In addition, the coating with a synthetic resin as a wear layer with the aid of pressure and temperature is described there. This is to be regarded as impracticable for similar reasons as lacquering (high technical effort, high technical know-how, disposal problems, etc.). In addition, coating with synthetic resins takes place at relatively high temperatures (approx. 200′C), which means a considerable energy requirement for such a system.

The resulting disadvantages are odour nuisance, no surface variations, demanding technology so that employees with great technical understanding are needed, exhaust air and disposal problems.

### SUMMARY OF THE INVENTION

The proposed solution is therefore based on the technical object of providing a device that enables the end customer to purchase a self-designed floor at the point of sale (POS), e.g. in a hardware store, which he can also take away immediately. It is possible to work either with one's own decors or with already existing ones (in digital form). For the employees at the point of sale, the operation and maintenance of the equipment used to produce the floor should be as simple and harmless as possible. There should be no emissions or odours. In addition, troubleshooting, maintenance and re-equipping of the system should be as simple as possible.

This technical object is solved by a method with features as described herein and a device with features as described herein.

Accordingly, a method for providing laminate panels provided with individualized decors, in particular wood-based laminate panels, for a party B, in particular an end user, is provided, comprising the following steps:
Providing at least one formatted laminate panel blank by a party A, in particular a laminate manufacturer, wherein the laminate panel blank comprises a carrier plate pressed with a coating as a print base coat and at least one backing and connecting elements inserted into the panel edges,
Printing of at least one decor individually selected by the end user on the laminate panel blank using digital printing;
Pressing at least one thermoplastic film onto the print decoration as a wear layer,
wherein the printing of the selected decoration and the pressing of the at least one thermoplastic film onto the printed decoration is performed at the point-of-sale (POS).

Party A shall in particular be understood to mean a laminate manufacturer, also suppliers, traders or the like, who provides a Party B with laminate panel blanks for customizing in the manner of an intermediate product.

Party B shall be understood to mean in particular an end user, including interior decorators or architects, who use or offer for use laminate panels as a finished end product for covering floors, walls and/or ceilings.

Accordingly, a method (and a device for carrying out this method) is provided whereby a non-individualized laminate panel blank is first provided by the manufacturer. As described in detail below, a large-format carrier board is pressed at the manufacturer's with a base coat layer, if necessary a primer and a backing, whereby the base coat layer has a uniform, preferably light colour. The base coat layer can be provided with structures. The pressed, large-format panel is divided into individual panels and provided with known locking elements at the side edges. The manufacturer thus provides small-format laminate panel blanks with a high degree of finishing (i.e. printing base coat and locking element), which can subsequently be customized by the end user.

The manufacturer delivers the small-format laminate panel blank to a point-of-sale (e.g. hardware store). Here, according to the present method, a decor individually designed by the end user is digitally printed and this printed decor is provided with a wear layer based on a film. The application of liquid lacquer or resin layers as a wear layer is thus avoided, so that the finishing process can be carried out more simply and safely. In the process, the end user also has the option of integrating their own decors or inlays into the floor. Complex multilayer structures on the laminate are not provided with the present process at the point of sale, as this would lead to an increase in the cost of the product, which is precisely what is not desired. Thus, no load distribution layer, stabilization layer or damping layers, e.g. of cork, felt, nonwovens, wood-plastic composite (WPC), glass-fiber-reinforced plastic, hotmelts or similar materials, are provided.

The system used for the present process at the point of sale comprises a magazine in which laminate panel blanks (coated, primed and provided with tongue and groove) are located. The laminate panel blanks are printed with a digital printer either with decors that the system supplier provides to the end user or with decors that the end user transfers to the system via a digital file (e.g. stored on a USB stick). It is also possible to integrate inlays, names, etc. into a decor provided by the system supplier. Further processing of the decor files is also possible via simple software (rotating, mirroring, enlarging, reducing, etc.). In addition, the result of the adjustments can be viewed not only on a screen but also on a printout. A film, optionally with a lacquer layer on top, is then applied to the print decor with the help of a heated roller.

The fact that the laminate flooring blanks are delivered to the POS solves the problem of supplying small quantities to end customers that has arisen due to customization. This means that minimal quantities (e.g. batch size 1) can be customized for the end user. This would not be possible with the laminate manufacturer itself. The possibility of individualizing a product by the end user himself is the maximum possible participation of the end user in the product manufacture.

Furthermore, all that is needed for the surface finish is a digital printer and roll lamination in the plank width. If required, foils for different usage classes can also be used, as this only requires the exchange of one roll.

The advantages resulting from the present method are manifold: the end product is ready immediately, modifications can be made to the decor, surfaces can be varied, a simple process can be carried out in a flexible system, and quantities can be provided to the customer's exact requirements.

As described, the laminate panel blank, with the print base coat, backing and locking elements, is provided by the laminate manufacturer.

The laminate panel blank comprises a wood-based panel as core or carrier board, whereby this can be a medium-density fibre (MDF), high-density fibre (HDF) or chipboard or rough chipboard (OSB) or plywood board and/or a wood-plastic board.

In one embodiment, an unsanded wood fibre board, in particular MDF or HDF, is used as a carrier board for the laminate panel blank, which is still provided with a pressed skin (rotting layer) on the upper side and has been annealed with an aqueous melamine resin on the upper side to fill the pressed skin.

The dimensions or measurements of the laminate panel blank correspond to the formats that are typically available in the trade (e.g. hardware stores). Thus, the laminate panel blank may have dimensions of 1395×195 mm with a thickness between 4 to 15 mm, preferably 6 to 12 mm. However, other formats would also be possible.

As explained above, the at least one laminate panel blank has a coating as a print base coat. This base coat is applied to large-format carrier panels by the manufacturer. In order to ensure particularly good printability of the laminate panel blanks produced in this way, the base coat is in particular coloured. In particular, several colours are possible, such as white, beige, yellow or brown.

In one embodiment, the at least one print bae coat comprises aliquid coating of a resin, preferably a formaldehyde resin, such as melamine-formaldehyde resin, urea-formaldehyde resin or melamine-urea-formaldehyde resin. After intermediate drying, a pigmented layer is applied to this base coat, e.g. with a binder base of casein or soy protein. White pigments such as titanium dioxide (TiO₂) can be used as colour pigments. Other colour pigments may be calcium carbonate, barium sulphate or barium carbonate. The liquid base coats can be applied to the surface of the carrier plate using a roller.

It is also conceivable that the base coat consist of at least one, preferably at least two or more successively applied layers or coatings, wherein the application quantity between the layers or coatings is the same or different, i.e. the application quantity of each individual layer may vary.

In another embodiment, the at least one print base coat comprises a coloured paper impregnated with a resin. In this case, the print base coat used are for example coloured papers, the colour of which corresponds to the lightest shade in the decor to be printed. If, as in the present case, the decor to be applied is not yet known, a white or at least very light base coat is advantageous. However, any other colour is also conceivable as a base coat.

In a further embodiment, the large-format panel provided with the at least one print base coat is pressed with a backing. This is usually done in a short-cycle press at the panel manufacturer. During the pressing process, a structure can be introduced into the print base coat.

It is also possible that at least one primer layer is applied to the at least one print base coat (at the panel manufacturer). Isocyanate-based compounds can be used as primers, whereby non-aromatic, aliphatic isocyanates, such as hexamethylene diisocyanate, isophorone diisocyanate, or prepolymers containing these isocyanates are particularly preferred. Silane-based primers can also be used, such as products from the company Inomat GmbH. These contain acidolysis products from silanes, e.g. from bis(3-trimethoxysilylpropyl)amine and p-toluenesulfonic acid.

The amount of liquid primer applied is between 1 and 30 g/m², preferably between 5 and 20 g/m² more preferably between 10 and 15 g/m².

A release film can be provided to protect the print decor and the primer from contamination and from sticking of the laminate flooring blanks during transport and storage to the POS. For example, films with a silicone coating can be used as release films.

The described steps of base coating and, if necessary, applying a primer layer and pressing take place in the large format at the manufacturer. The base coated large format is then also divided or formatted into the desired number of laminate panel blanks at the manufacturer.

The now formatted laminate panel blanks are provided with a lockable tongue-and-groove connection at the manufacturer on at least two opposite edges of the panel. This enables a simple and quick floating installation of the panels. Such tongue and groove joints are known from EP 1 084 317 B1, among others.

Accordingly, the laminate panel blank provided by the manufacturer comprises a wood-based material board as a carrier plate with at least one print base coat, optionally a primer layer provided on the print base coat, a backing opposite the print base coat and lockable tongue-and-groove joints provided on at least two opposite edges of the panel.

The laminate panel blanks are stored in a central warehouse at the laminate manufacturer. Beforehand, they can be cleaned and packaged in such a way that they can be printed or processed directly in the processing plant without the panels having to be cleaned again there. Only one type of panel now needs to be kept in stock, so that space-intensive storage of panels with different decors, different surface structures or different surfaces is no longer necessary.

The laminate panel blanks are then transported to a further processing company for customization. This can be, for example, a franchise business associated with the laminate manufacturer, a hardware store, an interior decorator, dealer or a floor installer.

In this process, the laminate panel blanks are unpacked from the transport-safe packaging. Then-as described above-a decorative layer with a decor according to the customer's immediate wishes is applied to the base coat or primer and covered by at least one wear layer.

As stated above, the at least one decor (individually selected by the end user) is applied to the laminate panel blank using a digital printing process. In digital printing, the printed image is transferred directly from a computer to a printing machine, such as a laser printer or inkjet printer. This eliminates the use of a static printing form. Decorative printing is done using the inkjet principle in a single-pass process where the entire width of the top side to be printed is covered, with the panels moving under the printer. However, it is also possible for the panel to be printed to be stopped under the printer and for the printer to pass over the surface at least once during printing.

The digital printing process makes it possible to select the decor according to the customer's wishes, as the decor can be provided in the form of individualized computer data/software. The laminate panel blanks are printed with a digital printer either with decors provided by the system supplier or with decors that the end user transfers to the system via a file. It is also possible to integrate inlays, names, etc. into a decor provided by the system supplier. Further processing of the decor files is also possible via simple software (rotating, mirroring, enlarging, reducing, etc.). In addition, the result of the adjustments can be viewed not only on a screen but also on a printout.

In the printing step, the laminate panel blank passes through a digital printer. This makes it possible, in particular, to print different decors quickly and easily on different panels one after the other without having to change over the printing unit to a new decor each time. Since only individual panels need to be printed and not large-format wood-based panels, as is the case with in the state of the art, the printing unit can be small and compact and thus space-saving and cost-effective.

The printing inks are grouped together in separate print head rows in the digital printer, whereby one or two rows of print heads can be provided for each colour. The colours of the digital printing inks are for example black, blue, red, reddish yellow, greenish yellow, optionally CMYK can also be used. The digital printing inks are optionally based on the same pigments used for analogue and/or digital printing with water-based inks. The digital inks are preferably based on UV inks. However, it is also possible to use water-based digital printing inks or so-called hybrid inks. After printing, the decorative print is dried and/or irradiated.

The printing inks are applied in an amount between 1 and 30 g/m², preferably between 3 and 20 g/m², more preferably between 3 and 10 g/m².

As mentioned above, a thermoplastic film is applied as a wear layer onto the printed decoration. In one embodiment, a transparent cover film made of a thermoplastic material, in particular thermoplastic polyurethane (TPU), polyethylene terephthalate (PET) or polypropylene (PP), is used. TPUs are aliphatic systems, as they are less sensitive to yellowing.

The films used have a thickness between 0.1 and 1 mm, preferably between 0.2 and 0.8 mm. They can have a single or multi-layer structure and contain mineral components (e.g. corundum particles) to improve wear resistance.

The transparent thermoplastic film is produced separately and fed online from a roll. In this process, the at least one thermoplastic film is applied to the printed laminate panel blank at a temperature that is up to 20° C. above the softening temperature of the thermoplastic material of the film. By heating the film above the softening point, good adhesion of the film to the printed layer is achieved.

The film is pressed on at a line pressure between 100 and 170 N/mm, preferably at 150 N/mm (an idealized line in a laminating line is assumed here).

In particular, the film is laminated or calendered. Calendering is preferably carried out with a textured roller to which temperature is applied. For the purposes of the present application, the term “calendering” is to be understood as the application of a thermoplastic film to a carrier sheet using heated rollers. In this process, the surface of the thermoplastic film is melted and, after curing, is bonded or welded to the carrier board at the surface and thus adheres to the carrier board. Accordingly, no gluing is necessary.

In a further embodiment, the at least one thermoplastic film is provided or coated with at least one lacquer layer. In this case, the thermoplastic film is provided together with the lacquer layer; i.e. the lacquer layer is already present in cured form on the film, so that application and curing of the lacquer layer at the POS is not necessary. The at least one lacquer layer, serves to improve the scratch resistance and to adjust the gloss level. The lacquer layer can contain nanoparticles, e.g. of silicic acid.

The lacquer layer may consist of at least one polyurethane or of radiation-curable acrylate-containing lacquers. Typically, the radiation-curable lacquers used contain (meth)acrylates, such as polyester (meth)acrylates, polyether (meth)acrylates, epoxy (meth)acrylates or urethane (meth)acrylates. It is also conceivable that the acrylate used or the acrylate-containing varnish is substituted or unsubstituted monomers, oligomers and/or polymers, in particular in the form of acrylic acid, acrylic ether and/or acrylic acid ester monomers, oligomers or polymers. Of importance for the present method is the presence of a double bond or unsaturated group in the acrylate molecule as defined. The polyacrylates may also be further functionalized. Suitable functional groups include hydroxy, amino, epoxy and/or carboxyl groups. The aforementioned acrylates enable cross-linking or curing in the presence of UV or electron beams (ESH).

The lacquer layer is applied to the thermoplastic film in an amount between 30 and 100 g/m², preferably between 60 and 80 g/m².

It is also possible that the at least one thermoplastic film and the lacquer layer optionally provided thereon are provided with a structuring. For this purpose, the heated roller for pressing on the thermoplastic film can have a structure. Roller changes can also be carried out automatically via a change system, so that structures can also be varied.

It is also possible for the structure in the register to run parallel to the decor, so-called EIR structure or decor-synchronous structure. For this purpose, position and speed are synchronized between the carrier plate to be structured and the structure generator (roller).

The present method can be used to produce a laminate panel, in particular a wood-based laminate panel, which has a layered structure comprising at least one backing, a carrier board, at least one print base coat, optionally at least one primer layer, at least one (individualized) printed decorative layer, at least one thermoplastic film and optionally at least one lacquer layer.

A device used for providing this laminate panel comprises
at least one digital printer for printing at least one decor on a laminate panel blank comprising a carrier plate pressed with a coating as a print base coat and at least one backing and connecting elements inserted into the panel edges, by digital printing; and
at least one roller device for pressing at least one thermoplastic film as a wear layer onto the print decoration.

The device also comprises at least one magazine in which laminate panel blanks (coated, primed and tongue and groove) are located.

In a further embodiment, a cleaning device can be arranged upstream of the printing unit or digital printer.

The at least one digital printer is connected to at least one electronic data processing device. The data processing device of the digital printer comprises an input device with which a selection of a design can be input, which is stored in the form of electronic data in a data memory, and an electrical controller which is set up to read the selected design from the data memory and to control the printing unit so that the selected design is printed.

The device also includes a display device via which the available decors or decors provided by the end user are displayed.

It is also possible that the at least one roller device comprises at least one roller with a structured roller. A change system can also be used to automatically change rollers so that structures can also be varied.

An essential advantage of the present device is that the at least one digital printer and the at least one roller device are adapted to the dimensions of the laminate panel blank, i.e. the digital printer and the roller device are adapted to the plank width and are thus more space-saving and cost-effective.

Specifically, the present method can be carried out in one variant, for example in a hardware store, as follows. A customer who needs laminate panels for a certain room size first receives information about the number of panels he needs. On a display device of a device with which the laminate panel blank can be finished as described above, he can view various decors that are available for selection. These decors are stored in the form of electronic data in a data memory within the device. Alternatively, the customer or end user can bring their own decor on a suitable data carrier (e.g. on a CD, DVD or USB stick). In this way, it is possible for the customer to print an individual decor on panels. After the customer has selected a decor, he enters this selection via the input device. In addition, the customer can choose how many laminate panel blanks are to be printed with the selected decor. Inside the device, the desired decor is now applied to a pre-coated profiled panel and this is covered with a thermoplastic film as a wear layer. It is possible for the end user to reorder individual panels at any time using the device described. This significantly increases flexibility in the production of laminate panels and even the smallest order quantities with a wide variety of decors can be produced in an economically viable manner.

### BRIEF DESCRIPTION OF THE DRAWING

The solution is explained in more detail below with reference to a figure and an example of an embodiment.

FIG. 1 shows a schematic representation of an embodiment of the present method.

### DESCRIPTION OF THE INVENTION

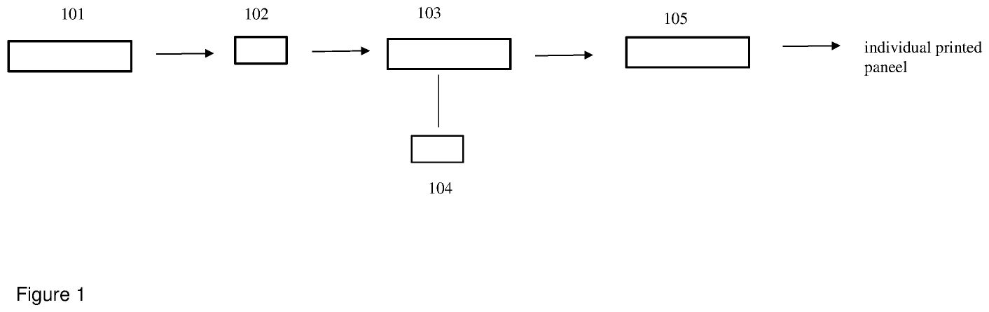

FIG. 1 shows a schematic representation of a process for finishing a laminate panel blank, such as may be carried out in a processing plant, for example a franchisee associated with the laminate manufacturer, a hardware store or similar.

The laminate panel blanks 101 are delivered from the laminate manufacturer to the processing plant in transport-safe packaging. In a first process step, the laminate panel blanks 101 are removed from this transport-safe packaging and fed into a magazine.

In the example of the process shown in FIG. 1, the laminate panel blanks 101 are then fed to a cleaning device 102, in which the surface of the laminate panel blanks 101 is cleaned of any dirt and dust that may have adhered and is thus prepared for printing. However, it is also conceivable that the laminate panel blanks 101 have been suitably cleaned in the laminate manufacturer's plant for subsequent printing. They may then have been cleaned and placed in the transport-safe packaging. For example, by sealing the transport packaging airtight in a film, it can be ruled out that the laminate panel blanks 101 subsequently have to be cleaned again before they are printed.

After the laminate panel blanks 101 have passed through the cleaning device 102, if necessary, they are aligned and spaced apart from each other to the desired distance. The laminate panel blanks 101 are then fed to a digital printer 103. Here, the surface of the panel 101 is printed with the decorative layer to be applied. The digital printer 103 has three print heads for this purpose. Depending on the desired decor, the digital printer 103 can also have more or fewer print heads. Connected to the digital printer 103 is an electronic data processing device 104, which has an input device not shown in FIG. 1, via which the user of a device for carrying out the process can select the desired decor. For this purpose, the electronic data processing device 104 has a display device via which the available decors, which are stored on an electronic storage medium, for example, are displayed to the user. From this selection, the user can select the desired print decor.

To ensure the best possible result, the decors are optimized and adapted in the data processing device 104 to the possible formats of the laminate panel blanks 101 to be printed.

After the top side of the laminate panel blanks 101 has been printed with a decor, the printed panels 101 leave the digital printer 103 and are fed to a roller device 105 in which a transparent thermoplastic wear film is pressed on. The film is cut to size after the pressing process. If necessary, cooling (roller cooling) can also be integrated into the process. After pressing the wear-resistant foil with the printed panel, the end user is provided with a laminate panel adapted to his individual wishes, which can be used, for example, as a flooring element or also for wall or furniture cladding.

### Example

Provision of the Laminate Danel Blanks at the Laminate Manufacturer:

The large-format wood-based panels are base coated. The base coat can either have a solid-coloured paper as a base or consist of a liquid coating with subsequent covering with a melamine resin coating. The liquid coating can be applied by roller application or also by digital printing.

In the case of an impregnate, a dyed paper is subjected to a special impregnation. First, the paper is filled with resin, then sharply squeegeed on the upper side with a knife squeegee and then given a resin coating on the underside to improve adhesion to the substrate.

Base coating is usually done on a large format (format 2800 mm×2070 mm with a thickness of 4 to 15 mm, preferably 6 to 12 mm).

In each case, subsequent pressing has been carried out in a short-cycle press with a counter-draught.

The laminate flooring blanks are then produced from this large format on a milling line.

A primer can be applied before or after formatting to improve the adhesion of the film applied later.

This primer is applied in a quantity of 10 to 20 g fi/m². It can be an isocyanate-based or silane-based primer (INOFLEX NI+). A separating film can be provided to protect the primer from soiling and from bonding of the laminate flooring blanks during transport and storage.

Locking profiles (fasteners and locking elements) are worked into the side edges of the formatted panel blanks, usually by milling and, if necessary, with plastic locking elements, then packaged, temporarily stored if necessary and shipped to the point of sale.

At the laminate manufacturer, a “ready-made” laminate in the colour white is produced and stored in stock, so to speak.

Refinement at the Point of Sale (e.g. Hardware Store):

The laminate panel blanks are unpacked and cleaned and fed into the system consisting of digital printer and roller device.

The system includes a magazine in which laminate panel blanks (coated, primed and tongue and groove) are located.

At the point of sale, the laminate flooring blanks are printed with a digital printer either with decors provided by the system supplier or with decors that the end user transfers to the system via a file. It is also possible to integrate inlays, names, etc. in a decor provided by the system supplier. Further processing of the decor files is also possible via simple software (rotating, mirroring, enlarging, reducing, etc.). In addition, the result of the adjustments can be examined not only on a screen but also on a printout.

A TPU film with a UV lacquer coating on the top is then laminated onto the print using a heated roller at a pressure of 150 N/mm and a temperature of 140° C. The film is fed from a roll. After the lamination process, it is cut to size. The blanks are transported through the laminating press by a guide, which is equipped to prevent damage to the profile areas during lamination.

The heated roller, which presses the film onto the print, is structured so that the lacquer coating surface can be restructured. The rollers can also be changed automatically via a changeover system so that structures can also be varied. The temperature used to apply the film is up to approx. 20° C. above the softening temperature of the thermoplastic from which the film was made. The fact that the laminate flooring blanks are delivered to the POS solves the problem of supplying end customers with small quantities, which has arisen due to customization. Furthermore, all that is needed for surface finishing is a digital printer and roll lamination in the plank width. If required, foils for different usage classes can also be used, as this only requires the exchange of one roll.

1. A method for providing laminate panels provided with individualized decors, in particular wood-based laminate panels, for a party B, in particular an end user, comprising the steps of:
providing at least one formatted laminate panel blank by a party A, in particular a laminate manufacturer, wherein the laminate panel blank comprises a carrier plate pressed with a coating as a print base coat and at least one backing and connecting elements inserted into the panel edges,
printing of at least one decor individually selected by the party B, in particular the end user, on the laminate panel blank by digital printing; and
pressing at least one thermoplastic film onto the printed decoration as a wear layer,
wherein the printing of the selected decoration and the pressing of the at least one thermoplastic film onto the printed decoration is performed at the point-of-sale (POS).

2. The method according to claim 1, wherein the at least one print base coat of the laminate panel blank comprises a resin provided with color pigments, preferably a pigmented formaldehyde resin.

3. The method of claim 1, wherein the at least one print base coat of the laminate panel blank is a colored paper impregnated with a resin.

4. The method according to claim 1, wherein the at least one print base coat of the laminate panel blank is provided with a texture.

5. The Method according to claim 1, wherein at least one primer layer is provided on the at least one print base coat of the laminate panel blank.

6. The method according to claim 1, wherein the at least one decorative print is provided in the form of individualized computer data/software.

7. The method according to claim 1, wherein the at least one thermoplastic film provided as a wear layer is a transparent cover film made of a thermoplastic material, in particular thermoplastic polyurethane (TPU), polyethylene terephthalate (PET) or polypropylene (PP).

8. The method according to claim 1, wherein at least one thermoplastic film is applied to the printed panel blank at a temperature that is up to 20° C. above the softening temperature of the thermoplastic material of the film.

9. The method according to claim 1, wherein at least one lacquer layer is provided on the at least one thermoplastic film.

10. The method according to claim 1, wherein the at least one thermoplastic film and the lacquer layer optionally provided thereon are provided with a structuring.

11. A laminate panel, in particular wood-based laminate panel, which can be produced in a method according to claim 1, comprising a layered structure comprising at least one backing, a carrier board, at least one print base coat, optionally at least one primer layer, at least one (individualized) printed decorative layer, at least one thermoplastic film and optionally at least one lacquer layer.

12. A device for providing a laminate panel provided with individualized decorations at a point-of-sale (POS) in a method according to claim 1, comprising
at least one digital printer for printing at least one decor on a laminate panel blank comprising a carrier plate pressed with a coating as a print base coat and at least one backing and connecting elements inserted into the panel edges, by digital printing; and
at least one roller device for pressing at least one thermoplastic film as a wear layer onto the print decoration.

13. The device according to claim 12, wherein the at least one digital printer is connected to at least one electronic data processing device.

14. The device according to claim 12, wherein the at least one roller device comprises at least one roller with a structured roller.

15. The device according to claim 12, wherein the at least one digital printer and the at least one roller device are adapted to the dimensions of the laminate panel blank.
